(19) United States
(12) Patent Application Publication
(10) Pub. No.: US 2014/0331024 A1
(43) Pub. Date: Nov. 6, 2014

(54) Method of Dynamically Adjusting Mapping Manner in Non-Volatile Memory and Non-Volatile Storage Device Using the Same

(71) Applicant: Skymedi Corporation, Hsinchu City (TW)

(72) Inventors: Yi-Cheng Wu, Hsinchu City (TW); Yi-Chun Liu, Hsinchu City (TW)

(73) Assignee: Skymedi Corporation, Hsinchu City (TW)

(21) Appl. No.: 13/960,800

(22) Filed: Aug. 7, 2013

Related U.S. Application Data
(60) Provisional application No. 61/818,884, filed on May 2, 2013.

(51) Int. Cl. G06F 12/06

(52) U.S. Cl. CPC G06F 12/06
USPC 711/209

(57) ABSTRACT

A method of dynamically adjusting a mapping manner for a non-volatile memory includes mapping a plurality of logical addresses to a plurality of physical addresses by a first mapping unit; storing data in the non-volatile memory by the first mapping unit; and mapping at least one logical address to at least one physical address by a second mapping unit according to the stored data.

### CROSS REFERENCE TO RELATED APPLICATIONS

This application claims the benefit of U.S. Provisional Application No. 61/818,884, filed on May 2, 2013 and entitled “Address transfer & data management for a non-volatile memory”, the contents of which are incorporated herein by reference.

### BACKGROUND OF THE INVENTION

1. Field of the Invention

The present invention relates to a method of dynamically adjusting a mapping manner in a non-volatile memory and a non-volatile storage device using the same, and more particularly, to a method of dynamically adjusting a mapping manner in a non-volatile memory capable of dynamically mapping logical address to physical address using cluster mapping and block mapping in the non-volatile memory according to an amount of valid data existing in the non-volatile memory and a non-volatile storage device using the same.

2. Description of the Prior Art

A memory controller is commonly utilized for task management in a memory system, especially in a non-volatile memory system. In general, since data stored in a non-volatile memory system may not be lost after electric power of the non-volatile memory system is cut off, the non-volatile memory system becomes an important means to store system data. Among those non-volatile memory systems, NAND flash memory, which has advantages of low power and high speed, becomes popular with the popularization of portable devices in recent years.

In the NAND flash memory, read/write operation is performed based on a unit of page, and erasing operation is performed based on a unit of block, where a block size is usually far greater than a page size. In general, a block may be composed of 64 or 128 pages. When a user needs to access data in the NAND flash memory, the corresponding data address should be mapped from the logical block to the physical block. There are two commonly used methods for this mapping: page mapping and block mapping. According to the page mapping method, the data address is mapped from the logical page to the physical page. In other words, when a page of new data needs to be written in the memory, an empty physical page is found and this new data is written in the physical page. At least one mapping table then records the address of the physical page corresponding to the logical page. When the page mapping method is applied, however, the size of the mapping tables becomes very large. Therefore, if there is a large amount of valid data in the NAND flash memory and page mapping is applied, when sequential write is performed, the memory controller may have to make a lot of efforts to merge valid data (ex: garbage collection) and update the mapping tables, which significantly reduces writing performance of the NAND flash memory.

In order to enhance the writing performance, the block mapping method can be applied. According to the block mapping method, the data address is mapped from the logical block to the physical block, so that the mapping table only needs to record the address of the physical block corresponding to each logical block. As mentioned above, a block size is far greater than a page size, which means that the number of blocks is far smaller than the number of pages in a memory system; hence the size of the mapping table can be reduced. According to the block mapping method, when a page of data in a first block needs to be updated by new data, a second block is selected and the new data is written into the corresponding physical page in the second block. In addition, data in other pages in the first block should be copied to the corresponding pages in the second block. When there is a large amount of valid data and sequential write is performed, the efficiency of updating the mapping table and performing data merge are enhanced if block mapping is applied.

However, when the amount of valid data is less, block mapping updates an entire block even if there is only one page of data required to be updated, which reduces efficiency considerably. Therefore, the industry has developed a hybrid mapping method combining block mapping and page mapping. The hybrid mapping method divides the physical block into a page mapping portion and a block mapping portion. However, in a conventional hybrid mapping system, the number of physical blocks in the page mapping portion and the number of physical blocks in the block mapping portion are always fixed. The physical blocks using page mapping cannot be re-allocated to the block mapping portion, and the physical blocks using block mapping cannot be re-allocated to the page mapping portion. Since page mapping and block mapping are preferable in different cases, such a hybrid mapping system cannot enjoy the benefits of page mapping and block mapping effectively in each case. Thus, there is a need for improvement over the prior art.

### SUMMARY OF THE INVENTION

It is therefore an objective of the present invention to provide a method of dynamically adjusting a mapping manner in a non-volatile memory capable of dynamically mapping logical address to physical address using cluster mapping and using block mapping in the non-volatile memory according to an amount of valid data existing in the non-volatile memory and a non-volatile storage device using the same.

The present invention discloses a method of dynamically adjusting a mapping manner for a non-volatile memory. The non-volatile memory comprises a plurality of physical blocks, and each of the plurality of physical blocks comprises a plurality of physical pages. The method comprises mapping a plurality of logical addresses to a plurality of physical addresses by a first mapping unit; storing data in the non-volatile memory by the first mapping unit; and mapping at least one logical address to at least one physical address by a second mapping unit according to the stored data.

The present invention further discloses a non-volatile storage device. The non-volatile storage device comprises a non-volatile memory, comprising a plurality of physical blocks, each of the plurality of physical blocks comprising a plurality of physical pages; and a memory controller, coupled to the non-volatile memory, for dynamically adjusting a mapping manner for the non-volatile memory by executing the following steps: mapping a plurality of logical addresses to a plurality of physical addresses by a first mapping unit; storing data in the non-volatile memory by the first mapping unit; and mapping at least one logical address to at least one physical address by a second mapping unit according to the stored data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a non-volatile storage device according to an embodiment of the present invention.

FIG. 2 is a schematic diagram of a logical block originally using cluster mapping re-allocated to use block mapping according to an embodiment of the present invention.

FIG. 3 is a schematic diagram of a block number distribution of the non-volatile memory according to an embodiment of the present invention.

FIG. 4 is a schematic diagram of a process according to an embodiment of the present invention.

### DETAILED DESCRIPTION

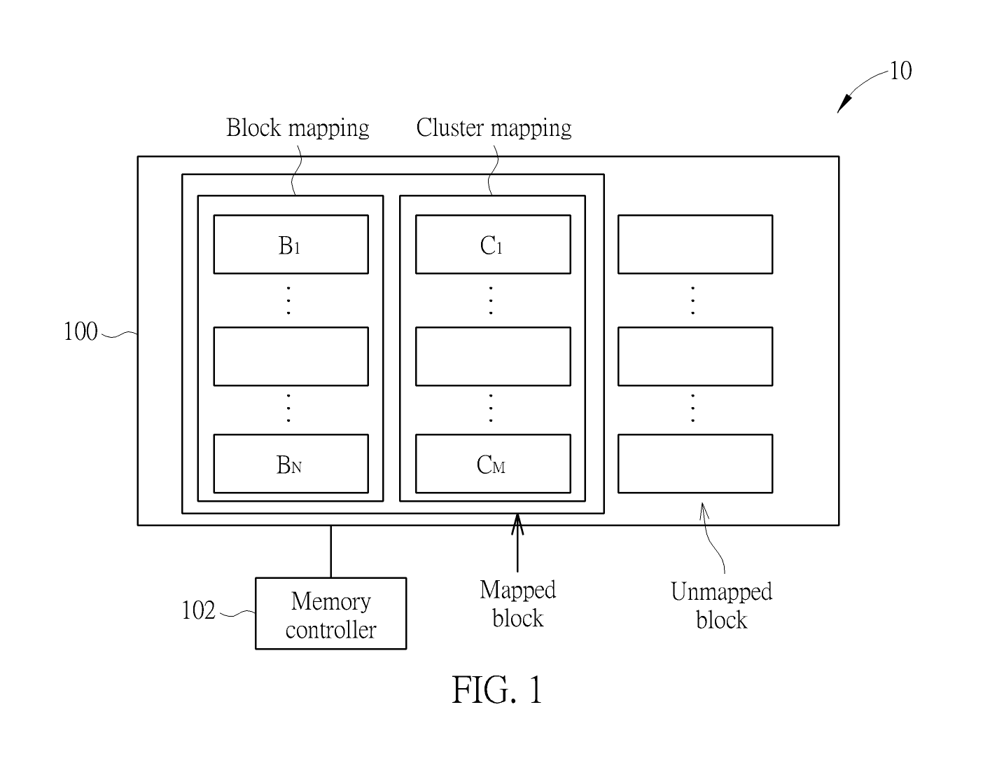

Please refer to FIG. 1, which is a schematic diagram of a non-volatile storage device 10 according to an embodiment of the present invention. As shown in FIG. 1, the non-volatile storage device 10 includes a non-volatile memory 100 and a memory controller 102. The non-volatile memory 100 includes a plurality of physical blocks. The physical addresses of the non-volatile memory 100 may be mapping to logical addresses either using cluster mapping or block mapping if data is stored in these physical addresses, and other physical addresses may be unmapped. The size of a cluster mapping unit is smaller than a page mapping unit, and thus far smaller than the size of a block mapping unit. The memory controller 102, coupled to the non-volatile memory 100, is utilized for managing the non-volatile memory 100.

Please note that, the memory controller 102 is capable of dynamically adjusting the mapping manner for the data stored in the non-volatile memory 100. More specifically, a block originally using block mapping may be re-allocated to use cluster mapping, and a block originally using cluster mapping may be re-allocated to use block mapping. For example, if there are X physical blocks in the non-volatile memory 100, there may be N physical blocks B₁-B_{N} using block mapping and M physical blocks C₁-C_{M} using cluster mapping, and the values N and M should be variable. For the physical blocks B₁-B_{N}, the logical block addresses are mapping to the physical block addresses. For the physical blocks C₁-C_{M}, the logical cluster addresses are mapping to the physical cluster addresses. N should be equal to a value between 0 and X, and when N=0, the mapping manner for the non-volatile memory 100 is equivalent to pure cluster mapping. M should also be equal to a value between 0 and X, and when M=0, the mapping manner for the non-volatile memory 100 is equivalent to pure block mapping.

As mentioned above, a mapping with a smaller unit such as page mapping or cluster mapping is preferable when the amount of valid data is less, and block mapping is preferable when the amount of valid data is large. Therefore, the amount of valid data can be considered as a threshold for determining the number of physical blocks to be allocated to use block mapping. In an embodiment, the memory controller 102 may monitor the amount of valid data in each logical block of the non-volatile memory 100. Data stored in the logical block may originally be mapping to physical clusters in several physical blocks using cluster mapping, and when the amount of valid data in the logical clusters within the logical block exceeds a specific amount, this logical block maybe re-allocated to use block mapping. In detail, data in the corresponding physical clusters may be moved to another physical block, and block mapping is applied to map the logical block to this physical block.

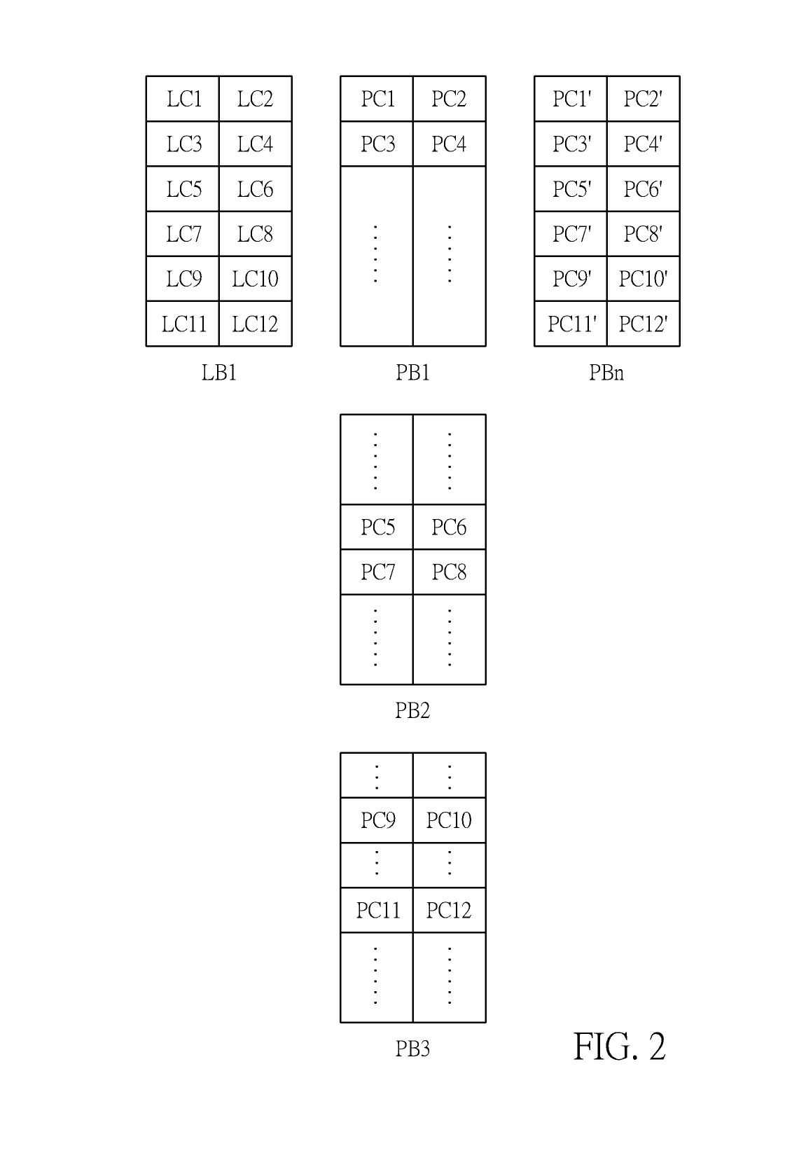

Please refer to FIG. 2, which is a schematic diagram of a logical block LB1 originally using cluster mapping re-mapped to use block mapping according to an embodiment of the present invention. As shown in FIG. 2, the logical block LB1 includes 12 logical clusters LC1-LC12, and valid data is stored in each logical cluster using cluster mapping. The logical clusters LC1-LC4 are mapping to physical clusters PC1-PC4 within a physical block PB1; the logical clusters LC5-LC8 are mapping to physical clusters PC5-PC8 of within a physical block PB2; and the logical clusters LC9-LC12 are mapping to physical clusters PC9-PC12 within a physical block PB3. When the amount of valid data exceeds the specific amount and the logical block LB1 is arranged to use block mapping, a new physical block PBn will be assigned. The data in each of the physical clusters PC1-PC12 is copied to the physical clusters PC1′-PC12′ of the physical block PBn, respectively. The data stored in the physical clusters PC1-PC12 is then marked as invalid data. The logical block LB1 can therefore be re-mapping to the physical block PBn using block mapping instead of cluster mapping.

In an embodiment, the memory controller 102 may determine a number of physical blocks among the plurality of physical blocks to use block mapping according to the total amount of valid data in the whole non-volatile memory 100. When the amount of valid data is smaller than a threshold, a larger number of the physical blocks may be allocated to use cluster mapping. When the amount of valid data is greater than the threshold, a smaller number of the physical blocks may be allocated to use cluster mapping. For example, the threshold may be determined to be 80 percent of the storage space of the non-volatile memory 100. If more than 80% of the storage space in the non-volatile memory 100 is filled with valid data, there may be 60% of the logical blocks mapping to the physical blocks using block mapping, and 40% of the logical blocks having logical clusters mapping to physical clusters in the physical blocks using cluster mapping. If less than 80% of the storage space in the non-volatile memory 100 is filled with valid data, there may be only 30% of the logical blocks mapping to the physical blocks using block mapping, and 70% of the logical blocks having logical clusters mapping to physical clusters in the physical blocks using cluster mapping.

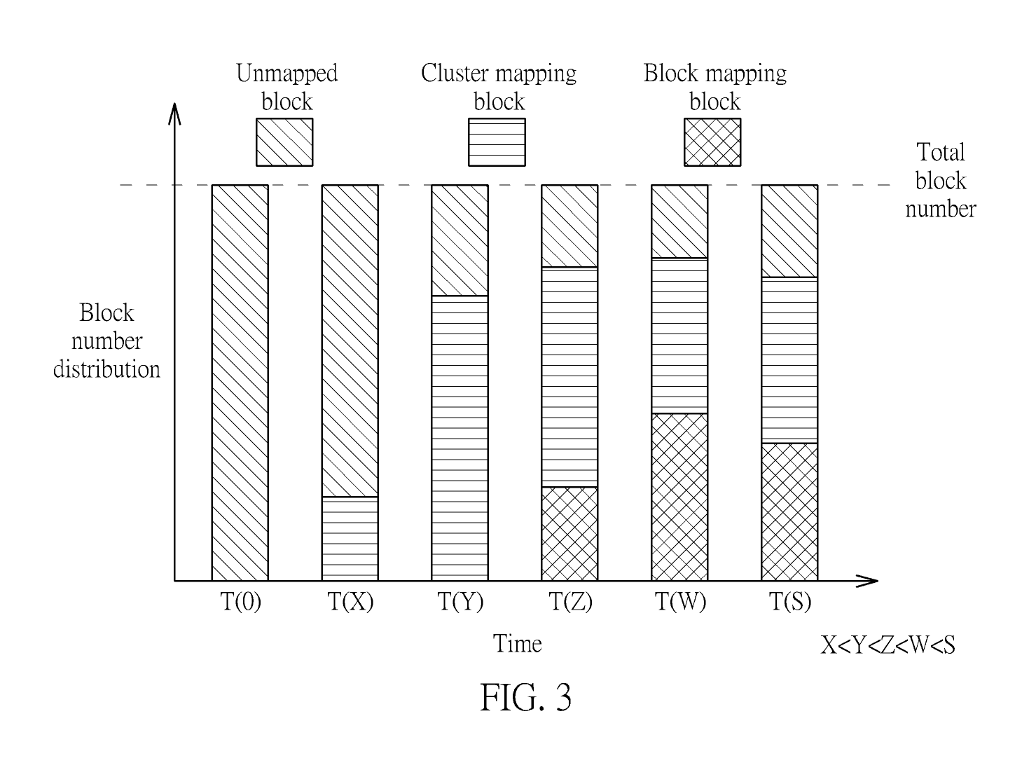

Please refer to FIG. 3, which is a schematic diagram of a block number distribution of the non-volatile memory 100 according to an embodiment of the present invention. As shown in FIG. 3, each physical block in the non-volatile memory 100 may be in a status of an unmapped block, a cluster mapping block or a block mapping block. At time T(0), when the non-volatile memory 100 is formatted or starts to be in use, there are no data stored in the non-volatile memory 100. In such a condition, when a data needs to be written into the non-volatile memory 100, cluster mapping may be applied, as illustrated at time T(X) and T(Y). Since the amount of valid data is still smaller than a specific threshold, the mapping between logical addresses and physical addresses are still using cluster mapping.

At time T(Z), the amount of valid data may exceed the specific threshold; hence block mapping starts to be applied. In an embodiment, when the amount of valid data in a specific logical block exceeds a threshold, this logical block is transferred to use block mapping. In detail, a new physical block is assigned and data stored in physical clusters mapping to logical clusters of the logical block is copied to the new physical block, and thus the logical block can be mapping to this new physical block using block mapping. In an embodiment, the amount of valid data in the whole non-volatile memory 100 exceeds a threshold, and the memory controller 102 may allocate a part of logical blocks originally using cluster mapping to change to use block mapping. In general, a logical block with more valid data is more likely to change to use block mapping.

At time T(W), the amount of valid data is increased continuously and exceeds another threshold, so that more logical blocks are mapping to physical blocks using block mapping. Since the amount of valid data is too large, the operation of collecting valid data through the non-volatile memory 100 may cause a lot of efforts on the memory controller 102 if cluster mapping is applied. In such a condition, it is more desirable to apply block mapping to the new arrival data or to transfer the original cluster mapping blocks to use block mapping instead.

At time T(S), a trim or discard instruction may be sent to the non-volatile memory 100. When data is moved within the non-volatile memory 100 due to the operations such as trim, wear-leveling and mapping transformation, some data stored in the non-volatile memory may be marked as invalid data. When the amount of invalid data increases and occupies considerable storage space, the memory controller 102 may use the garbage collection to erase the invalid data, in order to clear out the memory space. In general, a physical block with more invalid data is more likely to undergo the garbage collection. After garbage collection is performed on a physical block, the physical block is cleared out to be an unmapped block and can be utilized for storing new data. Therefore, the number of unmapped blocks may be increased.

Please note that, the present invention is capable of dynamically adjusting a mapping manner between logical addresses and physical addresses in the non-volatile memory by using either cluster mapping or block mapping. The ratio of storage space using block mapping or cluster mapping can be managed in different conditions such as the amount of valid data. Those skilled in the art can make modifications and alternations accordingly. For example, the threshold for the amount of valid data in a logical block or in the non-volatile memory can be determined arbitrarily. These parameters may be determined according to system requirements, in order to achieve maximum writing performance. Besides, the above method of dynamically adjusting the mapping manner can be applied for any types of non-volatile memories, which may include, but should not be limited to, a single-level cell (SLC) NAND flash memory, multi-level cell (MLC) NAND flash memory, magnetoresistive random access memory (MRAM) or ferroelectric random access memory (FRAM). In addition, the adjustment of block mapping blocks and cluster mapping blocks may be determined by any reasons or in any manners, which should not be limited to the amount of valid data only.

For example, the mapping manner of block mapping or cluster mapping may be controlled according to the properties of arrival data. If a data needs to be written into the non-volatile memory, the memory controller may determine whether the arrival data is hot data (e.g. data with size smaller than 4 kB) or cold data (e.g. data with greater size). If the arrival data is hot data, the memory controller may map a logical address to a physical address using cluster mapping. If the arrival data is cold data, the memory controller may map a logical address to a physical address using block mapping.

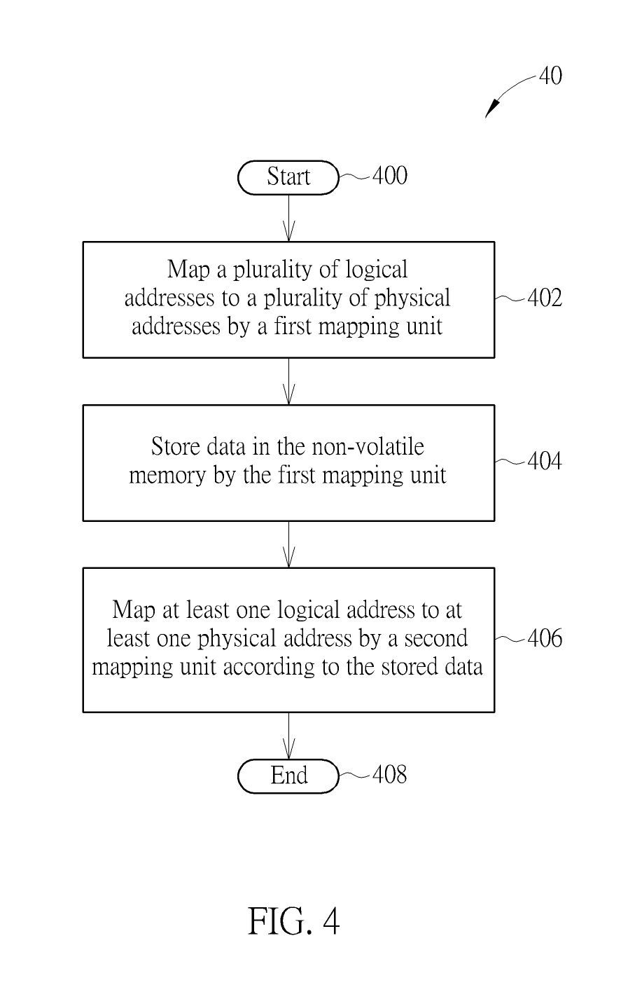

The above method of dynamically adjusting the mapping manner for a plurality of logical blocks in the non-volatile memory performed by the memory controller can be summarized into a process 40, as shown in FIG. 4. The process 40 includes the following steps:

Step 400: Start.

Step 402: Map a plurality of logical addresses to a plurality of physical addresses by a first mapping unit.

Step 404: Store data in the non-volatile memory by the first mapping unit.

Step 406: Map at least one logical address to at least one physical address by a second mapping unit according to the stored data.

Step 408: End.

The abovementioned mapping manners include a cluster mapping, page mapping and block mapping. It deserves to be mentioned here that the cluster mapping unit is smaller than the page mapping unit, and that the page mapping unit is smaller than the block mapping unit. In the above embodiments, the method of dynamically adjusting the mapping manners in the non-volatile memory uses cluster mapping and block mapping interchangeably. In other embodiments, the method of dynamically adjusting the mapping manners in the non-volatile memory may also use page mapping and block mapping interchangeably. In general, when there is less valid data, it is more desirable to apply the page mapping or cluster mapping (with smaller mapping unit); when there is more valid data, it is more desirable to apply the block mapping (with larger mapping unit).

In the prior art, if there is a large amount of valid data in the non-volatile memory and page mapping is applied, when sequential write is performed, the memory controller has to make a lot of efforts to merge valid data and update the mapping tables, which significantly reduces writing performance of the non-volatile memory. If the amount of valid data is less and block mapping is applied, the controller has to process an entire block even if there is only one page of data required to be updated, so that the efficiency will be reduced. Even if the hybrid mapping is applied, the number of blocks in the page mapping portion and the number of blocks in the block mapping portion are always fixed. Since page mapping and block mapping are preferable in different cases, such hybrid mapping systems cannot enjoy the benefits of page mapping and block mapping effectively in each case. In comparison, the present invention provides a method of dynamically adjusting a mapping manner in the non-volatile memory. The method is capable of storing data using cluster mapping and using block mapping dynamically in the non-volatile memory in different conditions. Therefore, the mapping manner of the present invention can be optimized for the writing performance of the non-volatile memory.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of dynamically adjusting a mapping manner for a non-volatile memory, the non-volatile memory comprising a plurality of physical blocks, each of the plurality of physical blocks comprising a plurality of physical pages, the method comprising:
mapping a plurality of logical addresses to a plurality of physical addresses by a first mapping unit;
storing data in the non-volatile memory by the first mapping unit; and
mapping at least one logical address to at least one physical address by a second mapping unit according to the stored data.

2. The method of claim 1, wherein a size of the first mapping unit is smaller then a size of the second mapping unit.

3. The method of claim 2, wherein the first mapping unit is a cluster mapping unit or a page mapping unit so a plurality of logical cluster addresses are mapping to a plurality of physical cluster addresses or a plurality of logical page addresses are mapping to a plurality of physical page addresses, and the second mapping unit is a block mapping unit so at least one logical block address is mapping to at least one physical block address.

4. The method of claim 3, wherein the step of mapping the at least one logical address to the at least one physical address by the block mapping unit according to the stored data, further comprises:
determining an amount of valid data among the stored data.

5. The method of claim 4, further comprising:
increasing a number of the mapping between the logical block address and the physical block address when the amount of valid data increases.

6. The method of claim 4, further comprising:
storing data in the non-volatile memory by the cluster mapping unit or the page mapping unit when the amount of valid data is smaller than a threshold.

7. The method of claim 4, further comprising:
applying a first number of the mapping between the logical block address and the physical block address when the amount of valid data is smaller than a threshold; and
applying a second number of the mapping between the logical block address and the physical block address when the amount of valid data is not smaller than the threshold;
wherein the first number is smaller than the second number.

8. The method of claim 4, wherein the stored data for determining valid data is a total amount of data stored in the non-volatile memory or in at least one logical block.

9. The method of claim 4, wherein when a plurality of logical clusters within a logical block are mapping to a plurality of physical clusters using the cluster mapping unit and the amount of valid data in the logical block exceeds a specific amount, the method further comprises:
moving the valid data from the plurality of physical clusters to a physical block; and
changing to apply the block mapping unit to map the logical block to the physical block.

10. The method of claim 3, further comprising:
storing data in the non-volatile memory by the block mapping unit when a size of the data is larger than a threshold.

11. The method of claim 4, wherein when a plurality of logical pages within a logical block are mapping to a plurality of physical pages using the page mapping unit and the amount of valid data in the logical block exceeds a specific amount, the method further comprises:
moving the valid data from the plurality of physical pages to a physical block; and
changing to apply the block mapping unit to map the logical block to the physical block.

12. A non-volatile storage device, comprising:
a non-volatile memory, comprising a plurality of physical blocks, each of the plurality of physical blocks comprising a plurality of physical pages; and
a memory controller, coupled to the non-volatile memory, for dynamically adjusting a mapping manner for the non-volatile memory by executing the following steps:
mapping a plurality of logical addresses to a plurality of physical addresses by a first mapping unit;
storing data in the non-volatile memory by the first mapping unit; and
mapping at least one logical address to at least one physical address by a second mapping unit according to the stored data.

13. The non-volatile storage device of claim 12, wherein a size of the first mapping unit is smaller then a size of the second mapping unit.

14. The non-volatile storage device of claim 13, wherein the first mapping unit is a cluster mapping unit or a page mapping unit so a plurality of logical cluster addresses are mapping to a plurality of physical cluster addresses or a plurality of logical page addresses are mapping to a plurality of physical page addresses, and the second mapping unit is a block mapping unit so at least one logical block address is mapping to at least one physical block address.

15. The non-volatile storage device of claim 14, wherein the step of mapping the at least one logical address to the at least one physical address by the block mapping unit according to the stored data, further comprises:
determining an amount of valid data among the stored data.

16. The non-volatile storage device of claim 15, wherein the memory controller further executes the following step to dynamically adjust the mapping manner for the non-volatile memory:
increasing a number of the mapping between the logical block address and the physical block address when the amount of valid data increases.

17. The non-volatile storage device of claim 15, wherein the memory controller further executes the following step to dynamically adjust the mapping manner for the non-volatile memory:
storing data in the non-volatile memory by the cluster mapping unit or the page mapping unit when the amount of valid data is smaller than a threshold.

18. The non-volatile storage device of claim 15, wherein the memory controller further executes the following steps to dynamically adjust the mapping manner for the non-volatile memory:
applying a first number of the mapping between the logical block address and the physical block address when the amount of valid data is smaller than a threshold; and
applying a second number of the mapping between the logical block address and the physical block address when the amount of valid data is not smaller than the threshold;
wherein the first number is smaller than the second number.

19. The non-volatile storage device of claim 15, wherein the stored data for determining valid data is a total amount of data stored in the non-volatile memory or in at least one logical block.

20. The non-volatile storage device of claim 15, wherein when a plurality of logical clusters within a logical block are mapping to a plurality of physical clusters using the cluster mapping unit and the amount of valid data in the logical block exceeds a specific amount, the method further comprises:
moving the valid data from the plurality of physical clusters to a physical block; and
changing to apply the block mapping unit to map the logical block to the physical block.

21. The non-volatile storage device of claim 14, wherein the memory controller further executes the following step to dynamically adjust the mapping manner for the non-volatile memory:
storing data in the non-volatile memory by the block mapping unit when a size of the data is larger than a threshold.

22. The non-volatile storage device of claim 15, wherein when a plurality of logical pages within a logical block are mapping to a plurality of physical pages using the page mapping unit and the amount of valid data in the logical block exceeds a specific amount, the method further comprises:
moving the valid data from the plurality of physical pages to a physical block; and
changing to apply the block mapping unit to map the logical block to the physical block.
